(19) United States
(12) Patent Application Publication
(10) Pub. No.: US 2013/0059532 A1
(43) Pub. Date: Mar. 7, 2013

(54) Partially Transparent Antenna

(71) Applicants: Alireza Mahanfar, Bellevue, WA (US); Elmer S. Cajigas, Sammamish, WA (US)

(72) Inventors: Alireza Mahanfar, Bellevue, WA (US); Elmer S. Cajigas, Sammamish, WA (US)

(73) Assignee: Microsoft Corporation, Redmond, WA (US)

(21) Appl. No.: 13/227,257

(22) Filed: Sep. 7, 2011

(51) Int. Cl. H04B 5/00; H01Q 1/24

(52) U.S. Cl. 455/41.1; 343/702

(57) ABSTRACT

A partially-transparent antenna is described that may be utilized to wirelessly transmit or receive data. In one or more implementations, an apparatus includes an antenna and one or more modules implemented at least partially in hardware. The antenna is formed from a material that is at least partially transparent. The one or more modules are communicatively coupled to the antenna to use the antenna to wirelessly transmit or receive data.

### BACKGROUND

Mobile communications devices such as wireless phones have become a common part in the everyday life of a wide variety of users. Indeed, the mobile communications device may serve as a primary point of contact for a variety of business and personal uses. For example, a business user may utilize the mobile communications device to receive email, a casual user may send text messages to friends, and so on.

The continuing increase in the amount of functionality that may be provided by a mobile communications device, however, has also caused an increase in the amount of resources utilized to support this functionality. This may cause an increase in size and cost as well as interference between the components that provide the functionality. Consequently, functionality of the mobile communications device may be limited from meeting its potential due by the amount of functionality to be included in the mobile communications device.

### SUMMARY

A partially transparent antenna is described that may be utilized to wirelessly transmit or receive data. In one or more implementations, an apparatus includes an antenna and one or more modules implemented at least partially in hardware. The antenna is formed from a material that is at least partially transparent. The one or more modules are communicatively coupled to the antenna to use the antenna to wirelessly transmit or receive data.

In one or more implementations, data is generated by a mobile communications device to be communicated to purchase a good or service. The data is transmitted wirelessly using near field communication by the mobile communications device using an antenna that is disposed proximal to a display of the mobile communications device such that at least a portion of a user interface displayed by the display is viewable through the antenna.

In one or more implementations, an apparatus includes a housing including an outer surface, a display disposed within the housing beneath the outer surface, and an antenna formed to be least partially optically transparent when viewed by the human eye and disposed proximal to the outer surface. The antenna and at least a portion of the outer surface are at least partially transparent when viewed by a human eye such that at least a portion of a user interface displayed by the display is viewable through the outer surface and the antenna. One or more modules are disposed within the housing and implemented at least partially in hardware to use the antenna to wirelessly transmit or receive data external to the housing for communication with another apparatus.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in accordance with one or more embodiments of devices, features, and systems for partially transparent antennas.

FIG. 2 illustrates an example implementation showing a portion of a computing device of FIG. 1 in greater detail that includes an antenna that is at least partially transparent such that a display is viewable through at least a portion of the antenna.

FIG. 3 illustrates another example implementation showing a portion of a computing device of FIG. 1 in greater detail that includes an antenna that is at least partially transparent such that a display is viewable through at least a portion of the antenna.

FIG. 4 depicts an example implementation in which a plurality of antennas are employed by the computing device of FIG. 1.

FIG. 5 is a flow diagram depicting a procedure in an example implementation in which an antenna and a touch sensor are formed from a conductor that is at least partially transparent.

FIG. 6 is a flow diagram depicting a procedure in an example implementation in which an antenna that is at least partially transparent is used to purchase a good or service using near field communication.

FIG. 7 illustrates various components of an example device that can be implemented in various embodiments as any type of a mobile device to implement embodiments of devices, features, and systems described herein.

### DETAILED DESCRIPTION

Overview

Although traditional mobile communications devices (e.g., mobile phones) were configured to provide a wide variety of functionality to users, this functionality could be limited by interference between the functionality as well as limitations on an amount of components that may be used to provide the functionality. Therefore, although the mobile communications device was generally considered useful by consumers, the functionality that could be employed by the mobile communications device was not able to reach its true potential.

Antennas that are at least partially transparent are described. In one or more implementations, an antenna of a mobile communications device is formed to appear at least partially transparent to a human eye. For example, the antenna may be formed from a material that is at least partially transparent, such as indium tin oxide (ITO) or other transparent conductive material. In this way, a number of locations at which the antenna may be employed on an apparatus may be expanded, such as to be employed as part of a display device, as part of a transparent housing of a mobile communications device, leverage one or more touch sensors, and so on. A variety of different wireless techniques may employ the antenna.

For example, the mobile communications device may be configured to include a secure element that is implemented in hardware to be resistant to tampering and “snooping.” Therefore, data may be stored within the secure element that has a decreased likelihood of being discovered, which may serve to support a wide variety of functionality.

One example of this functionality is an ability to store credentials that are usable to purchase goods or services. For example, the secure element may be configured to answer challenges, provide account information, and so on and thus function as an “eWallet.” In this way, a user may utilize the mobile communications device in much the same way as a traditional credit card to purchases goods or services of interest by transmitting data using the at least partially transparent antenna. A variety of other examples are also contemplated, further discussion of which may be found in relation to the following figures.

In the following discussion, a variety of example implementations of a mobile communications device (e.g., a wireless phone) are described. Additionally, a variety of different functionality that may be employed by the mobile communications device is described for each example, which may be implemented in that example as well as in other described examples. Accordingly, example implementations are illustrated of a few of a variety of contemplated implementations. Further, although a mobile communications device having one or more modules that are configured to provide telephonic functionality are described, a variety of other types of apparatus are also contemplated, such as personal digital assistants, mobile music players, dedicated messaging devices, portable game devices, netbooks, and so on as further described in relation to FIG. 7.

Example Implementations

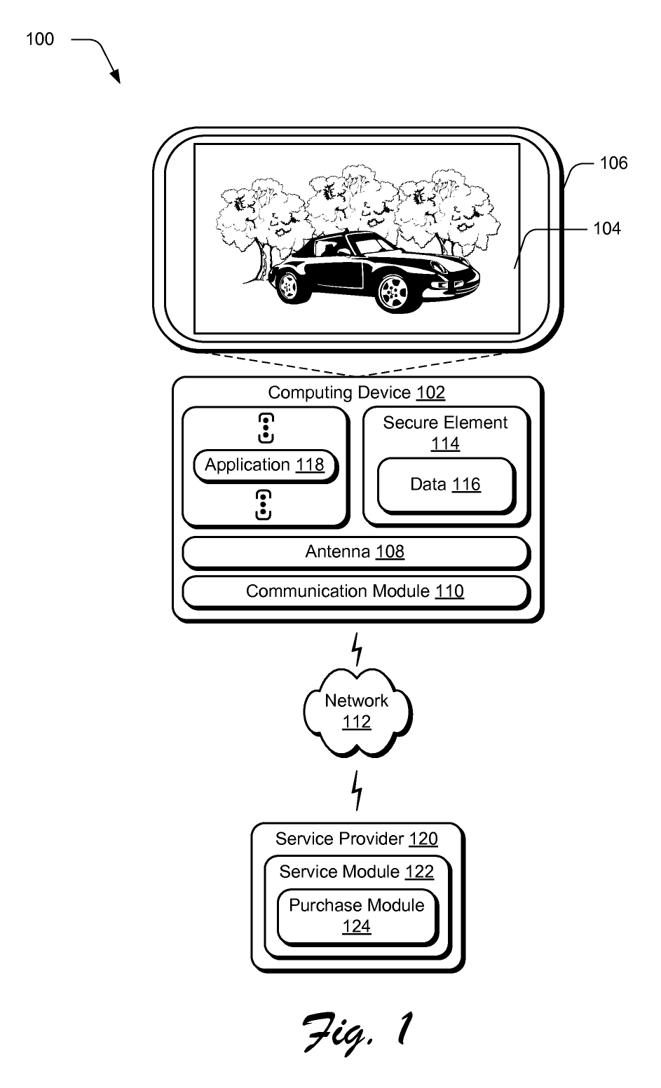

FIG. 1 is an illustration of an example implementation of an environment 100 that is operable to employ the techniques described herein. The environment includes a computing device 102 that is illustrated as a mobile communications device, such as a wireless phone, tablet computer, and so on. The computing device 102 in the illustrated example includes a display 104 that is disposed within a housing 106, such as an LCD, OLED, and so on. The housing 106 may also take a variety of forms, such as to be graspable by a hand of a user, as part of a desktop configuration (e.g., a tower), and so forth.

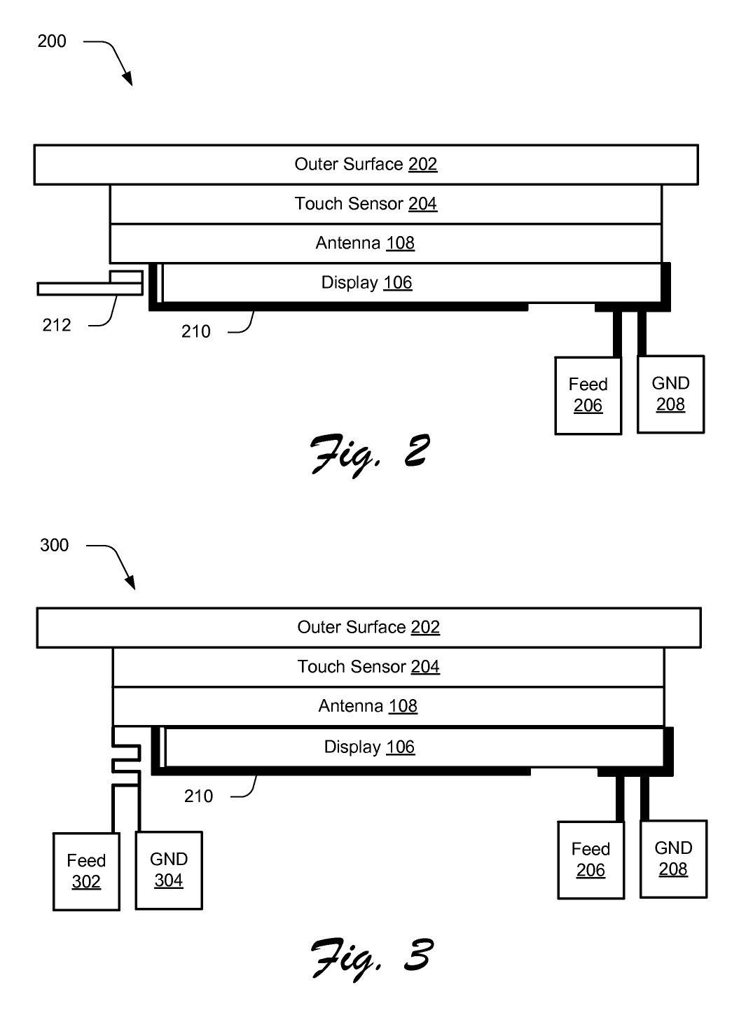

The computing device 102 is also illustrated as including an antenna 108. The antenna 108 may be formed in a variety of ways, one example of which is to be at least partially transparent when viewed by a human eye. For example, the antenna 108 may be formed using nanotechnologies such as to have a form factor that is difficult of a human eye to see, such as carbon nanotubes that are not visible to the human eye, unaided. In another example, conductive materials that are at least partially transparent are utilized to form the antenna 108, such as transparent conductive oxides (TCO), indium tin oxide (ITO), and so on. A variety of other examples are also contemplated, further discussion of which may be found beginning in relation to FIG. 2.

The computing device 102 is further illustrated as including a communication module 110 that may be utilized to communicate wirelessly over a network 112 using the antenna 108. For example, the communication module 110 may include telephone functionality to make and receive telephone calls, such as by employing a telephone module to communicate via a plain old telephone service (POTS), wireless network (e.g., cellular and/or Wi-Fi), and so on.

As described above, near field communication (NFC) is a communication technique that generally utilizes a relatively limited range (e.g., two centimeters) that is provisioned for techniques such as mobile ticketing, mobile payment, wireless (e.g., Bluetooth) pairing, electronic ticketing, electronic money, travel cards, identity documents, electronic keys, and so on. Thus, the data 116 contained in the secure element 114 of the computing device 102 of FIG. 1 may be configured to support a wide variety of these techniques.

The communication module 110 may also include a variety of other functionality, such as to capture content, form short message service (SMS) text messages, multimedia messaging service (MMS) messages, emails, status updates to be communicated via a social network service or micro-blog, communicate using near field communication (NFC) techniques, and so on. For instance, the communication module 110 may also support browser functionality to browse the network 112, communicate with another computing device 102 using NFC to purchase a good or service as further described below, and so on.

Although the network 112 is illustrated as the Internet, the network may assume a wide variety of configurations. For example, the network 108 may include a wide area network (WAN), a local area network (LAN), a wireless network, a public telephone network, an intranet, a near field communication (NFC) network, for communication using radio frequency identification (RFID) techniques, and so on. Further, although a single network 112 is shown, the network 108 may be representative of multiple networks.

The computing device 102 is further illustrated as including a secure element 114. In one or more implementations, the secure element 114 is representative of functionality to support secure communications and/or data storage of the computing device 102. For example, the secure element 114 may be implemented using a tamper-resistant integrated circuit to resist “snooping” as well as physical removal from the computing device 102. This may be performed in a variety of ways, such as by a manufacturer of the device, e.g., by covering a surface-mounted integrated circuit with an epoxy that helps to prevent snooping of the circuit as well as causing the circuit to break if removal is attempted.

In implementations, the secure element 114 includes functionality to perform encryption and/or decryption operations, which may be used to maintain integrity of the data 116 stored therein. For example, the secure element 114 may use an encryption key to perform a decryption operation and expose a result of the operations to other functionality of the computing device 102, such as to one or more applications 118 that are executable by the computing device 102. Thus, the secure element 114 may receive data to be decrypted from the application 118, decrypt the data using the encryption key (e.g., a private key), and then expose a result of the decryption operation (i.e., the decrypted data) to the application 118. Therefore, inclusion of the data 116 (which may include the encryption key) in the secure element 114 may help to protect the data 116 from discovery “outside” the secure element 114 by keeping the data 116 from being exposed “in the clear” during the decryption operation.

A variety of other functionality may also be supported through use of the secure element 114. For example, the data 116 of the secure element 114 may support a protected communication channel with a service provider 120 via the network 112 to supply data that may be used to purchase a good or service.

In one instance, a user of the computing device 102 may interact with the communication module 110 or other functionality (e.g., an application 118) to navigate to a service provider 120 over the network 112, such as the Internet. In another instance, this navigation may be performed over the network 112 using near field communications techniques, e.g., at a range of approximately two centimeters or less. For example, a user may “tap” the computing device 102 against a computing device of the service provider 120 (e.g., a purchase terminal) at a physical premises of the service provider 120. A variety of other examples are also contemplated.

Regardless of whether NFC or remote network (e.g., Internet) techniques are utilized, the computing device 102 may leverage the secure element 114, the communication module 110, and the antenna 108 to communicate data 116 to the service provider 102 via a secure channel to a service module 122 of the service provider. For example, the data 116 may include credentials that are usable to purchase a good or service. The data 116 may also include one or more encryption keys that are usable to secure the credentials for communication “outside” the secure element 114, such as to the service module 122 of the service provider 120.

The service module 122 is representative of functionality to provide one or more services for access via the network 112. An example of one of these services is illustrated as a purchase module 124 that is representative of functionality involved in processing a transaction to purchase a good or service. For instance, the purchase module 124 may be configured to help process credentials such as credit card information either directly at the service provider 120 or indirectly through contact with a financial institution.

Thus, the computing device 102 may communicate with the service provider 102 using the secure element 114, communication module 110, and antenna 108 to purchase a good or service, e.g., without having a user manually enter the credentials to perform the transaction. A wide variety of other communication techniques may also be employed by the antenna 108 and the communication module 110, such as for relatively limited range wireless communication (e.g., Bluetooth), medium range communication such as Wi-Fi, WiMAX, and wide area communication such as techniques utilized for wireless telephone networks. Discussion of example configurations of the antenna 108 may be found beginning in relation to FIG. 2.

Generally, the terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the techniques described below are platform-independent, meaning that the techniques may be implemented on a variety of commercial computing platforms having a variety of processors.

FIG. 2 illustrates an example implementation 200 showing a portion of the computing device 102 of FIG. 1 in greater detail. In this example, an outer surface 202 of the housing 106 is shown, beneath which is positioned a touch sensor 204, the antenna 108, and the display 104. Although illustrated as having similar thicknesses for clarity of text in the figure, it should be readily apparent that the thickness of the outer surface 202, touch sensor 204, antenna, 108, and display device 106 may vary greatly.

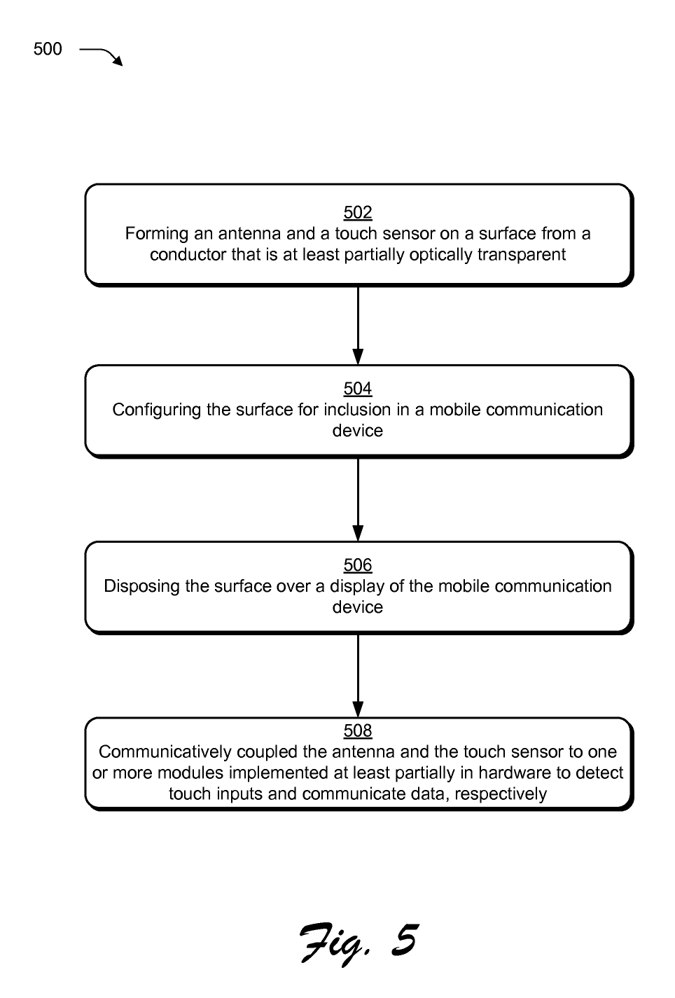

The touch sensor 204 in this case is configured to support touchscreen functionality of the computing device 102. For example, the touch sensor 204 may be configured to support capacitive touch sensing techniques to as further described in relation to FIG. 4. Other touch sensing techniques are also contemplated.

The antenna 108 is displayed as beneath the touch sensor 204, but may be disposed in a variety of positions, such as between the outer surface 202 and the touch sensor 204. The efficiency of the magnetic power transfer of the antenna 108 may be configured based on a loop area, number of turns, and resistance of a trace used to form the antenna 108 which is a function of the trace width and thickness as well as conductivity of the trace. Therefore, in one or more implementation these factors are used to configure the antenna 108 for use in conjunction with a contemplated wireless communication technique.

For example, because NFC communication is typically short range (e.g., the antenna is positioned in a near-field zone in which magnetic near-fields are dominant) the efficiency of the link can be relatively low when compared with other communication techniques that involve a greater range, e.g., Wi-Fi and mobile telephone networks as described above. Consequently, the antenna 108 for near field communication techniques may be formed from a wide variety of different optically transparent conductors, such as Indium Tin Oxide (ITO) or other optically transparent films.

Further, as the touch sensor 204 may also employ similar optically transparent conductors, similar processes may be utilized to form both the touch sensor 204 and antenna 108 during manufacture. By using the same process and technology, the antenna 108 may be formed with the touch sensor 204 without employing an additional step. In one or more implementations, the touch sensor and the antenna 108 may even share the same conductor.

In the illustrated example, the display 104 is driven using a feed 206 and ground 208 and surrounded by a metal display frame 210. The antenna 108 is driven by a chip resonator 212 such that the frequency of the antenna 108 may be driven and detected by the chip resonator 212, i.e., to transmit or receive data wirelessly.

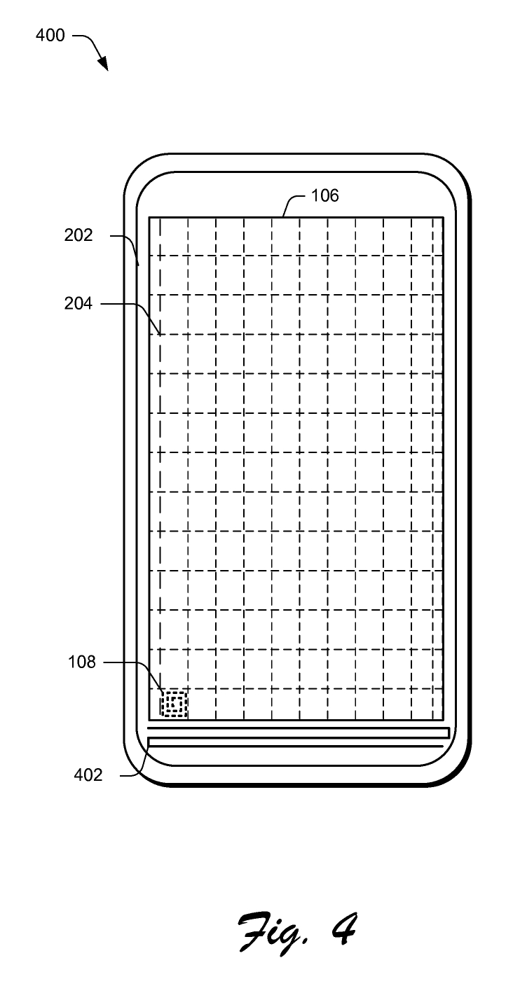

The antenna 108 may also be driven directly as shown in the example implementation of FIG. 3. In this example, a feed 302 and a ground 304 are communicatively coupled to the antenna 108 directly to transmit or receive data wirelessly. Thus, in these examples the display is viewable through at least a part of the antenna 108, the outer surface 202, and one or more touch sensors 204. A variety of other examples are also contemplated, an example of which is shown in the following figure.

FIG. 4 depicts an example implementation 400 in which a plurality of antennas are employed by the computing device 102. In this example, a touch sensor 204 is depicted using phantom lines as a grid formed from a partially transparent conductor to detect coordinates of a touch input. As before, the touch sensor 204 may be disposed beneath the outer surface 202 and within a housing 106. The outer surface 202 in this example is at least partially transparent and extends beyond a display area of the display 104.

A portion of an antenna 108 is also illustrated, using phantom lines, as being formed from an optically transparent conductor. The computing device 102 also includes an area beneath the outer surface 202 but outside of an available display area of the display 104.

In this example, this space is leveraged by another antenna 402 that may or may not be optically transparent. For example, the antenna 402 may be formed as a trace from a highly conductive material (e.g., a metal such as copper) such that even though it is beneath the outer surface 202 a user does not view a portion of the display 104 through the antenna 402.

As illustrated, the antenna 402 may be formed as a multi-turn antenna that is routed “around” a display area of the display 104. Thus, the computing device 102 may leverage the antennas 108, 402 using a variety of techniques, such as together to support a common wireless communication technique, configure each for different wireless communication techniques, and so on. Further discussion of an antenna that is at least partially optically transparent may be found in relation to the following procedure.

Example Procedures

The following discussion describes partially transparent antenna techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 and example implementations 200-400 of FIGS. 1-4, respectively.

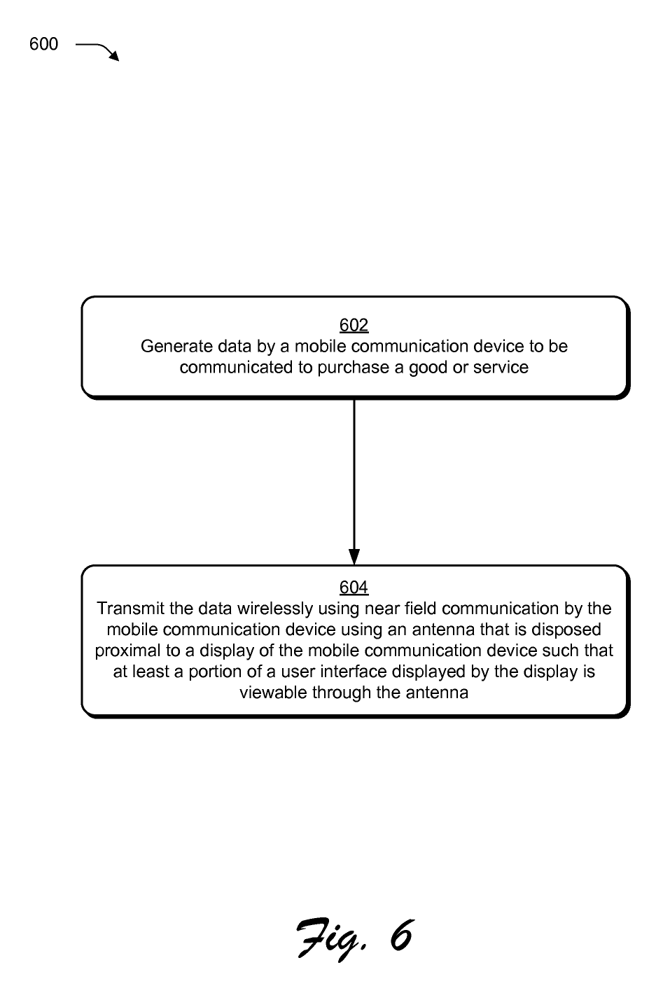

FIG. 5 depicts a procedure 500 in an example implementation in which an antenna and a touch sensor are formed from a conductor that is at least partially transparent. An antenna and a touch sensor are formed on a surface from a conductor that is at least partially optically transparent (block 502). For example, the antenna and the touch sensor may be formed using a same process to define traces on the surface that form the antenna and the touch sensor. The process, for instance, may be a process that was traditionally utilized to form a touch sensor but in this instance also forms the antenna without additional process steps.

The surface is configured for inclusion in a mobile communications device (block 504). This may include packaging, arrangement, inclusion of connection to form a communicative coupling, and so on.

The surface is disposed over a display of the mobile communications device (block 506), examples of this were shown in FIGS. 2 and 3. In this way, the display 104 is viewable through the antenna 108 and the touch sensor 204.

The antenna and the touch sensor are also communicatively coupled to one or more modules implemented at least partially in hardware to detect touch inputs and communicate data, respectively (block 508). Thus, the antenna 108 and the touch sensor 204 may be used to support touch and data communication techniques are previously described.

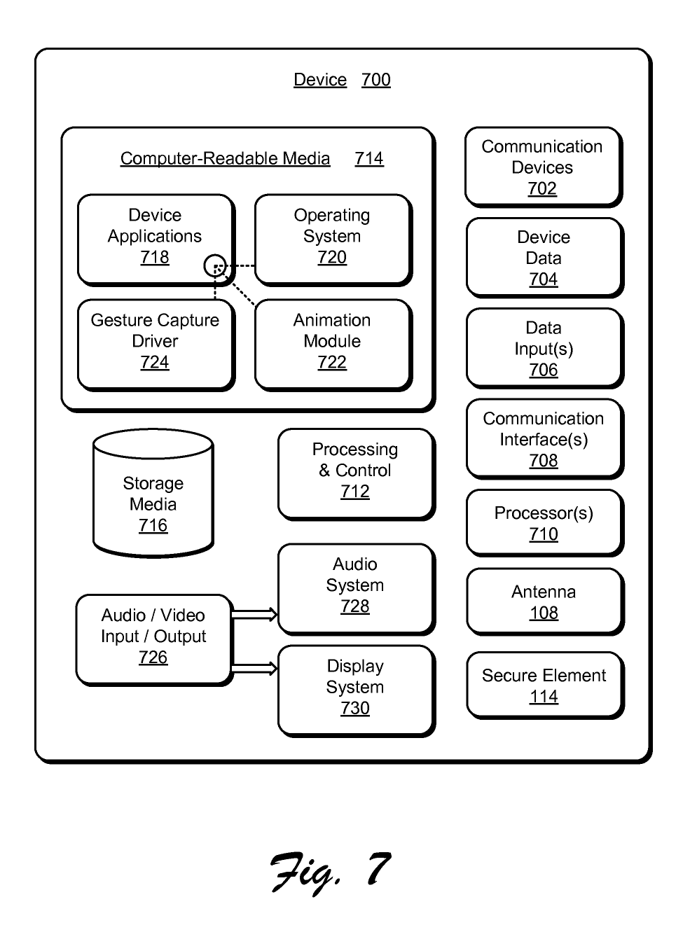

FIG. 6 depicts a procedure 600 in an example implementation in which an antenna that is at least partially transparent is used to purchase a good or service using near field communication. Data is generated by a mobile communications device to be communicated to purchase a good or service (block 602). The data, for instance, may be generated by a secure element 114 to form a secure communication channel, generate credentials usable to purchase the good or service, and so on.

The data is transmitted wirelessly using near field communication by the mobile communications device using an antenna that is disposed proximal to a display of the mobile communications device such that at least a portion of a user interface displayed by the display is viewable through the antenna (block 604). The antenna for instance, may be formed from an optically transparent conductor and/or sized such that it is not viewable by a human eye, unaided. This antenna may then be used to performed near field communication using the data to purchase the good or service, such as through communication of credit card credentials. A variety of other examples of data are also contemplated.

Example Device

FIG. 7 illustrates various components of an example device 700 that can be implemented as any type of computing device as described with reference to FIGS. 1-4 to implement embodiments of the techniques described herein. Accordingly, the device 700 as illustrated includes the antenna 108 and may also include the secure element 114 as previously described.

Device 700 also includes communication devices 702 that enable wired and/or wireless communication of device data 704 (e.g., received data, data that is being received, data scheduled for broadcast, data packets of the data, etc.) using the antenna 108. The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and an input/output module 724 that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof. Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. An apparatus comprising:
an antenna formed from a material that is at least partially transparent; and
one or more modules implemented at least partially in hardware and communicatively coupled to the antenna to use the antenna to wirelessly transmit or receive data.

2. An apparatus as described in claim 1, wherein the antenna appears to be transparent when viewed by a human eye.

3. An apparatus as described in claim 1, further comprising a display device and wherein at least a portion of the display device is viewable through the antenna.

4. An apparatus as described in claim 1, wherein the display device is disposed beneath an outer surface that is at least partially transparent to the human eye further comprising a second antenna that is disposed beneath the outer surface and proximal to the display device but not between the display device and the outer surface, the antenna and the second antenna usable to wirelessly transmit or receive the data.

5. An apparatus as described in claim 4, wherein the second antenna is not formed from the material that is at least partially transparent.

6. An apparatus as described in claim 1, wherein the one or more modules are configured to communicate the data via the antenna using one or more near field communication (NFC) techniques.

7. An apparatus as described in claim 6, wherein the one or more near field communication (NFC) techniques have an operating range of approximately two centimeters.

8. An apparatus as described in claim 6, wherein the data communicated using the one or more near field communication (NFC) techniques is usable in part to purchase a good or service.

9. An apparatus as described in claim 8, wherein the data is stored within a secure element of the apparatus.

10. An apparatus as described in claim 1, wherein the one or more modules are also configured to communicate using telephone functionality.

11. A method comprising:
generating data by a mobile communications device to be communicated to purchase a good or service; and
transmitting the data wirelessly using near field communication by the mobile communications device using an antenna that is disposed proximal to a display of the mobile communications device such that at least a portion of a user interface displayed by the display is viewable through the antenna.

12. A method as described in claim 11, wherein the antenna is disposed between the display and an outer surface of a housing, the outer surface is at least partially transparent to a human eye such that a user interface displayed by the display is viewable through the outer surface and at least a portion of the antenna.

13. A method as described in claim 11, wherein the transmitting is performed using one or more near field communication (NFC) techniques.

14. A method as described in claim 13, wherein the one or more near field communication (NFC) techniques have an operating range of approximately two centimeters.

15. A method as described in claim 14, wherein the data is stored within a secure element of the apparatus.

16. An apparatus comprising:
a housing including an outer surface;
a display disposed within the housing beneath the outer surface;
an antenna formed to be least partially optically transparent when viewed by the human eye and disposed proximal to the outer surface such that the antenna and at least a portion of the outer surface are at least partially transparent when viewed by a human eye such that at least a portion of a user interface displayed by the display is viewable through the outer surface and the antenna; and
one or more modules disposed within the housing and implemented at least partially in hardware to use the antenna to wirelessly transmit or receive data external to the housing for communication with another apparatus.

17. An apparatus as described in claim 12, wherein the housing is configured to be held in a user's hand.

18. An apparatus as described in claim 12, wherein the one or more modules are configured to communicate the data via the antenna using one or more near field communication (NFC) techniques.

19. An apparatus as described in claim 18, wherein the data communicated using the one or more near field communication (NFC) techniques is usable in part to purchase a good or service.

20. An apparatus as described in claim 19, wherein the data is stored within a secure element of the apparatus.
